(19) United States
(12) Patent Application Publication
(10) Pub. No.: US 2013/0103571 A1
(43) Pub. Date: Apr. 25, 2013

(54) SYSTEM AND METHOD FOR DETERMINATION AND REPORTING OF CREDIT USE AND IMPACT ON CREDIT SCORE

(71) Applicant: CreditXpert Inc., Baltimore, MD (US)

(72) Inventors: David Chung, Baltimore, MD (US); Thierry Marbach, Baltimore, MD (US); Devang Saraiya, Baltimore, MD (US)

(73) Assignee: CREDITXPERT INC., Baltimore, MD (US)

(21) Appl. No.: 13/646,977

(22) Filed: Oct. 8, 2012

Related U.S. Application Data
(60) Provisional application No. 61/543,986, filed on Oct. 6, 2011.

(51) Int. Cl. G06Q 40/02

(52) U.S. Cl. CPC G06Q 40/025
USPC 705/38

(57) ABSTRACT

Disclosed is a system and method for the automated generation and display of an electronic, graphical representation of the effect of a consumer's credit card usage as a percentage of credit limit on such consumer's credit score. The presentation may show each credit card account with a graphical view of the level of usage on each of a user's card accounts and further shows in which category that usage level falls. The levels of credit usage are classified for each card account into qualitative categories. Each category is designed to communicate to the consumer the statistical association between the usage level on that account and credit scores.

### CROSS REFERENCE TO RELATED APPLICATION

This application is based upon and claims priority from co-pending U.S. Provisional Patent Application Ser. No. 61/543,986 entitled “System And Method For Determination And Reporting Of Credit Use And Impact On Credit Score,” filed with the U.S. Patent and Trademark Office on Oct. 6, 2011, by the inventors herein, the specification of which is incorporated herein by reference.

### FIELD OF THE INVENTION

This invention relates generally to credit forecasting, and more particularly to a system and method for the automated generation of an electronic, graphic display of the effect of credit card usage as a percentage of credit limit on a consumer's credit score.

### BACKGROUND OF THE INVENTION

When a consumer applies for any kind of consumer financing such as an auto loan, student loan, mortgage, new credit card or an increase to credit limits on their credit card, the lender must evaluate their credit worthiness before making the decision to extend financing to them. One of the commonly used tools that lenders use is a credit score which is a numerical representation of a consumer's credit worthiness. There are several kinds of credit scores and nearly all of these consider usage levels on the consumer's card accounts as an important determining factor of the credit score. How consumers use their available credit can have a significant impact on their credit scores. Typically, lower balances on accounts, in comparison to the credit limits, are better for the commonly used consumer credit scores.

Consumers may be able to calculate their usage levels on individual accounts easily; however they often do not have the technical know-how to determine the statistical association of these usage levels to credit scores.

While lacking in the prior art, a visual representation would provide a way to quickly understand the score effect of usage levels on various card accounts in categories ranging, for example, from Very Poor to Great. These categories may be calculated based on data analysis of a large population of consumers' usage and the associated credit scores. Unfortunately, consumers do not have easy access to knowledge about the categories of usage levels, and thus lack tools for easily, and preferably visually, understanding the statistical association between their credit usage levels and their credit scores.

### SUMMARY OF THE INVENTION

Disclosed is a system and method for generating a visual representation of the statistical association between the levels of usage of the credit line on card accounts and a credit score. With regard to certain aspects of an embodiment of the invention, the presentation may show each card account with a graphical view of the level of usage on each of a user's card accounts and further shows in which category that usage level falls. The levels of credit usage are classified for each card account into qualitative categories. Each category is designed to communicate to the consumer the statistical association between the usage level on that account and credit scores.

Prior to the system and method described herein, consumers had no way of understanding how different levels of usage on their card accounts relate to credit scores. Most consumers would probably know that they were carrying balances, but would not know the statistical association of their usage levels with high or low credit scores. A few informed consumers might be aware of general rules of thumb, such as “avoid using more than 10% of the credit limit on your cards.” However, the depth of information provided by the proposed method would not be known to a consumer. However, the system and method described herein will provide an easy method by which the consumer can visually understand the statistical association between each account's usage levels and credit scores.

### BRIEF DESCRIPTION OF THE DRAWINGS

The numerous advantages of the present invention may be better understood by those skilled in the art by reference to the accompanying figures in which:

FIG. 1 is an exemplary system for implementing a credit usage analysis engine according to certain aspects of an embodiment of the invention.

FIG. 2 is an exemplary display of a visual representation of the effect of a consumer's credit card usage as a percentage of credit limit on their credit score according to certain aspects of an embodiment of the invention.

FIG. 3 is an alternative view of the exemplary display of FIG. 2.

FIG. 4 is an exemplary graphical user interface incorporating the display of FIG. 2.

FIG. 5 is a schematic representation of exemplary hardware suitable for use with the system of FIG. 1.

### DETAILED DESCRIPTION OF THE PREFERRED EMBODIMENTS

The following description is of a particular embodiment of the invention, set out to enable one to practice an implementation of the invention, and is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

As used throughout this specification, the following terms shall have the meanings indicated.

A registered account is an account that a consumer registers with an account aggregation service, so that the aggregation service can then retrieve periodically the information regarding that account from the lender's data systems. A consumer may have several accounts and register only a few accounts with an account aggregation service.

An account aggregation service compiles important pieces of account information (balances, credit limits, loan amounts, payment due dates, etc.) from financial institutions for all accounts that the consumer chooses to register with such a service. These accounts may be bank savings/checking accounts, credit card accounts, loan accounts, etc. Such services typically update the information frequently and can be considered to have the most up-to-date information about the consumer's registered accounts in a single place.

A card account is a credit account that can have revolving payment terms, such as a credit card. These types of accounts do not have to be paid in full each month; however in most cases a minimum payment is due each month.

Credit limit is the most a consumer is permitted to borrow on a particular card account.

Running balance is the most recently updated balance for a card account after considering all the credits and debits posted to that account. Running balance can change when a consumer makes a payment (repays the loan, fully or partially) or charges something to the account (makes a purchase) or due to fees and penalties (late payment charges, etc.) that the card's issuer might charge.

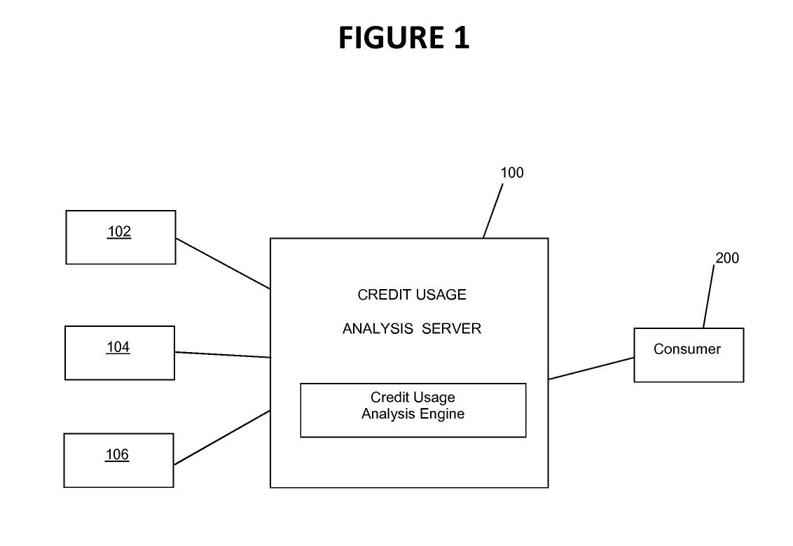

Now, with regard to certain aspects of a particularly preferred embodiment of the invention, and with regard to the schematic view of FIG. 1, the system and method described herein may be implemented on a financial application platform implementing a credit usage analysis engine 100 using data from a financial account aggregation service 102, and optionally reporting services 104 and/o4 online banking systems 106. Optionally, still other sources of financial information relating to a consumer 200 may be used, including by way of non-limiting example credit balance and credit limit data being manually entered by a consumer 200, without departing from the spirit and scope of the invention. In each case, however, the data format should include balances and credit limits for card accounts.

Credit usage analysis engine 100 is preferably executed on a computer that may communicate with account aggregation service 102 (and optionally credit report services 104 and online banking systems 106), and with a computer operated by consumer 200, across a computer network, including preferably a wide area network such as the Internet.

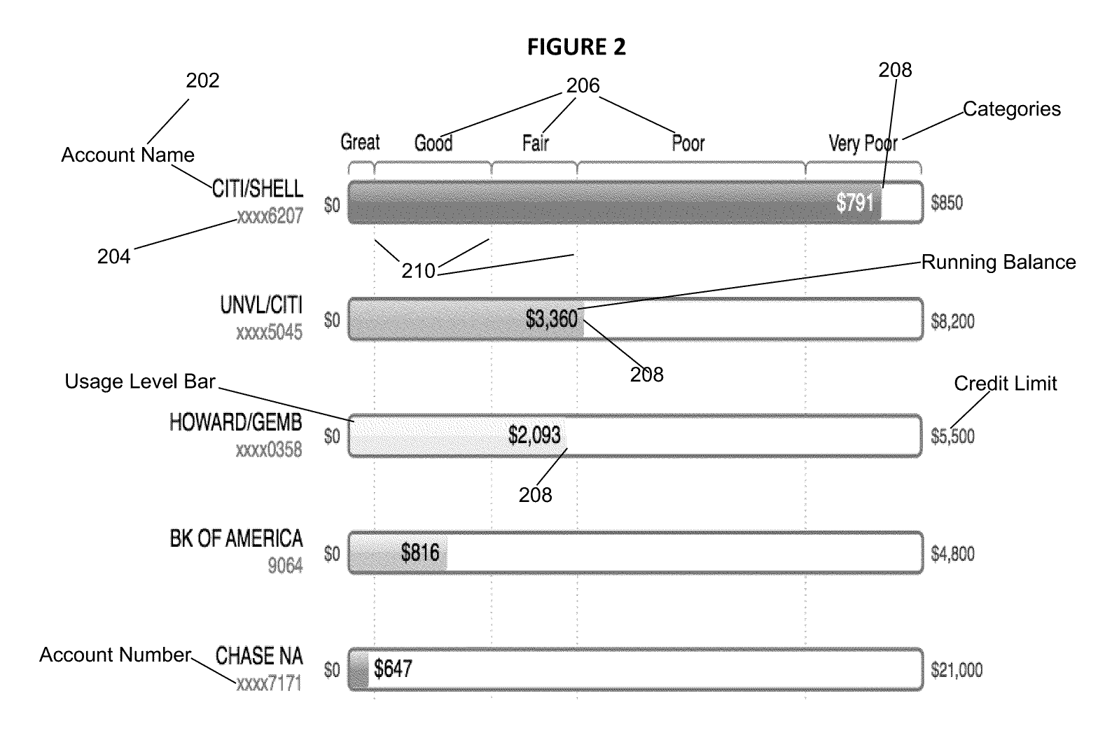

A preferred embodiment of a method according to the invention involves presenting information for each card account that the consumer 200 has registered with the service provided by credit usage analysis engine 100. As shown in FIG. 2, for each such account, its identification information (account name 202 and account number 204) is preferably presented. Each of the consumer's 200 card accounts may then be categorized by its usage level 206. The main categories and exemplary fill colors associated with them may include:

1: Great—Dark green

2: Good—Light Green

3: Fair—Yellow

4: Poor—Orange

5: Very Poor—Red

6: Over limit—Red

Of course, more or fewer categories may be used, and any other color selections to visually identify and distinguish each category, without departing from the spirit and scope of the invention. In this exemplary case, for categories 1 through 6, the usage level 208 may be visually presented as a horizontal bar, with the bar filled with color in proportion to the usage level on that account.

When the usage bar graph is presented, the starting point of the usage bar is preferably marked with $0 to indicate the lowest level a balance may normally reach on that account. The credit limit of the card account is preferably provided on the right side of the bar. The Running balance for each card account is likewise preferably displayed within the bar graphic for that account. The bar graphic is filled with a color that is determined by the category in which the card account falls.

The display also preferably has vertical lines 210 that show visually the boundaries between categories.

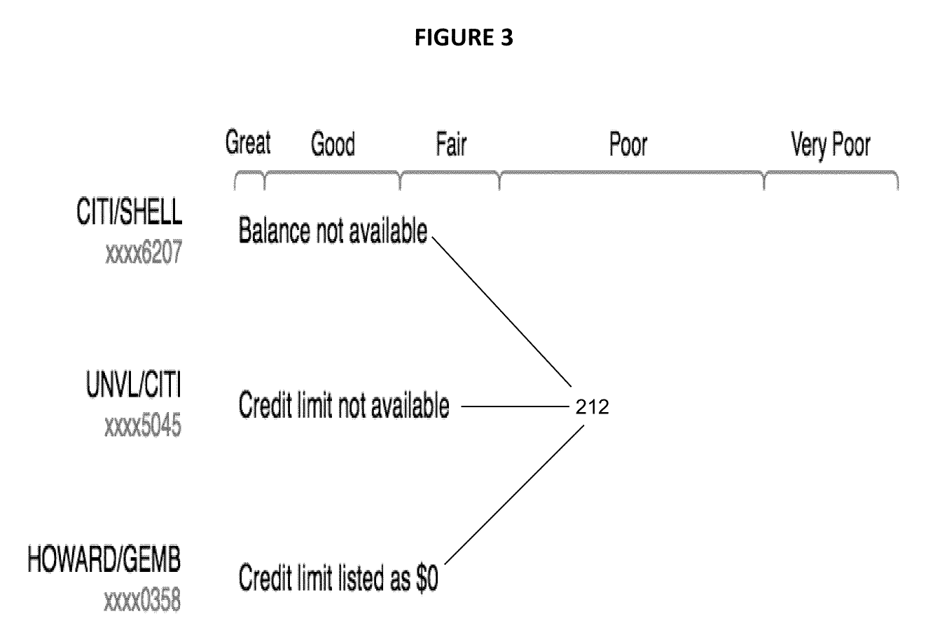

As shown in FIG. 3, in order to handle situations in which the usage level of an account cannot be computed, the method may use special categories configured to provide relevant information to the consumer when data contains either missing or non-realistic values.

No bar graph is presented for card accounts that are in the special categories. Rather, a short text description 212 of the particular special category may be presented to the consumer.

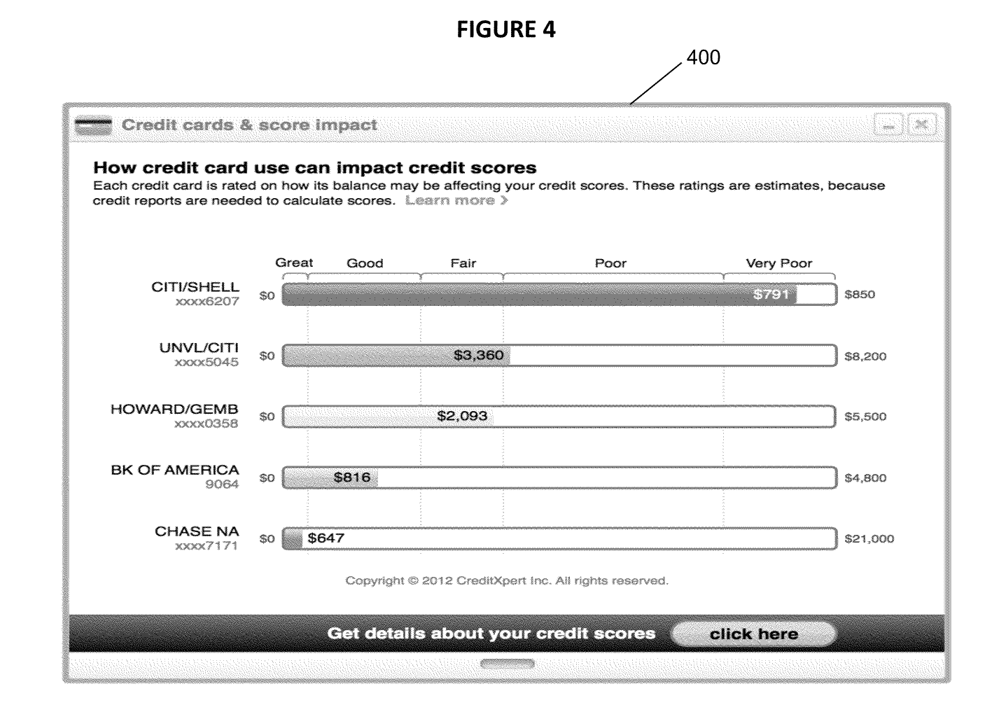

FIG. 4 provides an exemplary graphical user interface 400 that may be transmitted to consumer 200 by credit usage analysis engine 100, which incorporates the visual representation of the effect of the consumer's credit card usage, as a percentage of credit limit, on their individual consumer credit score.

### Logic to Calculate the Categories' Boundaries

The boundaries for the categories 206 discussed above are preferably calculated from a data sample that is preferably drawn from a population with varying credit characteristics. From each of these, a single account may be chosen at random and its usage level is plotted against the credit score for that credit file. From the graph of a large sample one can determine the boundaries (values b1, b2, b3, and b4 below) at which the usage levels are associated with different score levels (on average).

As someone skilled in the art will recognize, this method is dependent on the population chosen to determine the category boundaries. In this exemplary embodiment, a broad population was chosen to calculate the category boundaries described below; however, a different population may be chosen to fit other characteristics that might be deemed as important to the consumer without departing from the spirit and scope of the invention. One such exemplary set of category boundary values could be as follows:

b1=4.5

b2=25

b3=40

b4=80

The logic to generate the categories is as follows. First, in the general case, when the user has at least one credit card (or card account) with non-missing balance and credit limit amounts (and credit limit >0), the following determinations are made:
Calculate the available credit usage, referred to below as ‘usage’, as (Running balance* 100/Credit Limit) on that account
Calculate which ‘category’ the usage falls in as follows:
   Category=1, for 0≦usage<b1
   Category=2, for b1≦usage<b2
   Category=3, for b2≦usage<b3
   Category=4, for b3≦usage<b4
   Category=5, for b4≦usage<100
   Category=6, for usage>100 (for overlimit accounts)
In the graphical presentation, accounts are preferably sorted by descending order of credit usage. Each category number (i.e., 1, 2, 3, 4, 5) corresponds to a categorization of “Great,” “Good,” “Fair,” “Poor” and “Very Poor,” respectively. For card accounts that fall in category 6, instead of displaying the balance in the bar, the word ‘Overlimit’ is preferably presented to the consumer, alerting them to the fact that the running balance on the account exceeds its credit limit. Certain generally used credit scoring models treat over limit card accounts as particularly bad.

It is anticipated that in addition to using credit balance and credit limit values, a method in accordance with certain aspects of the invention could employ additional information in determining a categorization, such as whether the account is open or closed, whether the account is issued by a bank, the specific type of account (e.g., revolving, charge card, etc.), and the like, all without departing from the spirit and scope of the invention.

With regard to treatment of the aforementioned special categories, the following protocol is preferably executed:
When Running balance is missing:
   The account will be presented.
   No bar graphic presented, instead text “Balance not available” will be presented.
   Category=S1.
When Credit limit is missing:
   Account will be presented.
   No bar graphic presented, instead text “Credit limit not available” will be presented.
   Category=S2.
When Credit limit is zero:
   Account will be presented.
   No bar graphic presented, instead text “Credit limit listed as $0” will be presented.
   Category=S3.
When Credit limit is missing and the running balance is also missing:
   Account will be presented.
   No bar graphic presented, instead text “Credit limit not available” will be presented.
   Category=S4.
When Credit limit is zero and the running balance is also missing:
   Account will be presented.
   No bar graphic presented, instead text “Credit limit listed as $0” will be presented.
   Category=S5.
When there are no card accounts (or the user has not registered any accounts to the application):
   No bar graphic presented, instead text “Currently there are no accounts to display” will be presented.

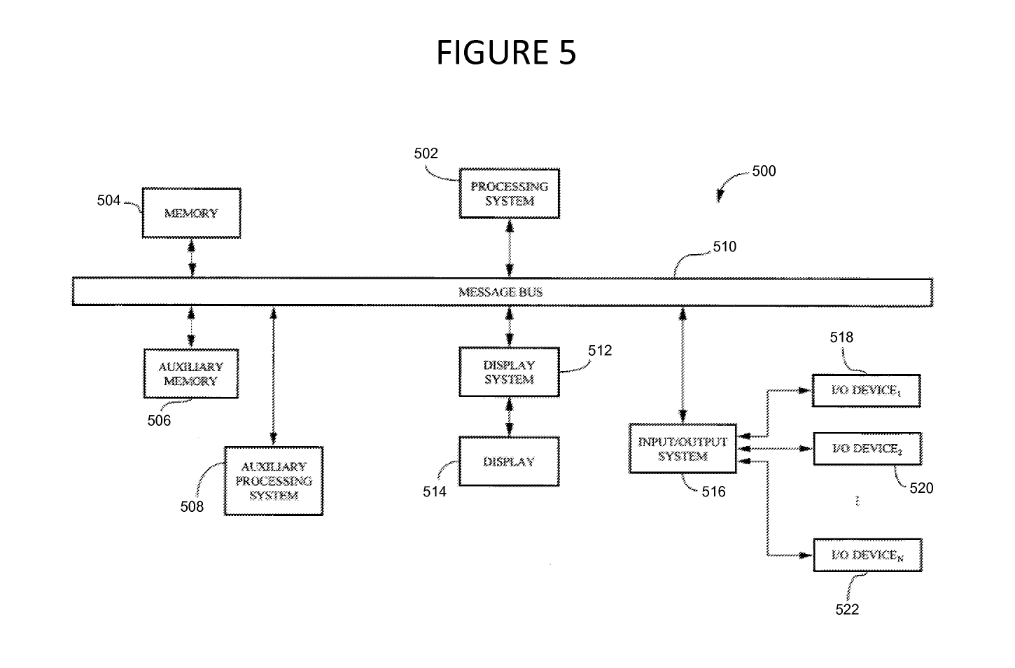

Credit usage analysis engine 100 may be hosted on one or more server computers configured to communicate with client and other interconnected computing devices using TCP/IP packets. An exemplary hardware system generally representative of a computing device suitable for such uses is shown in FIG. 5. In each case, a central processing system 502 controls the hardware system 500 of the credit usage analysis engine 100. A central processing unit such as a microprocessor or microcontroller for executing programs is included in the central processing system 502 for the performance of data manipulations and controlling the tasks of the hardware system 500. A system bus 510 provides the communication with the central processor 502 for transferring information among the components of the hardware system 500. Facilitating information transfer between storage and other peripheral components of the hardware system may be a data channel that may be included in bus 510. Further, the set of signals required for communication with the central processing system 502 including a data bus, address bus, and control bus is provided by bus 510. It is contemplated that any state of the art bus architecture according to promulgated standards may be utilized for bus 510, for example industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and so on.

A main memory 504 and auxiliary memory 506 (including an auxiliary processing system 508, as required) may be provided. The storage of instructions and data for programs executing on the central processing system 502 is provided by main memory 504. Typically semiconductor-based memory such as dynamic random access memory (DRAM) and/or static random access memory (SRAM) is used for the main memory 504. However, main memory 504 may utilize other semi-conductor-based memory types, such as synchronous dynamic random access memory (SDRAM), Rambus dynamic random access memory (RDRAM), ferroelectric random access memory (FRAM), and so on. The storage of instructions and data that are loaded into the main memory 504 before execution is provided by auxiliary memory 506. The storage capabilities provided by the auxiliary memory 506 may include semiconductor based memory such as read-only memory (ROM), programmable read-only memory (PROM), erasable programmable read-only memory (EPROM), electrically erasable read-only memory (EEPROM), or flash memory (block oriented memory similar to EEPROM). Alternatively, a variety of non-semiconductor-based memories, including but not limited to floppy disk, hard disk, magnetic tape, drum, optical, laser disk, compact disc read-only memory (CD-ROM), write once compact disc (CD-R), rewritable compact disc (CD-RW), digital versatile disc read-only memory (DVD-ROM), write once DVD (DVD-R), rewritable digital versatile disc (DVD-RAM), and other varieties of memory devices as contemplated may be used for auxiliary memory 506.

Auxiliary processors of the auxiliary processing system 508, which are discrete or built into the main processor, may be included in hardware system 500. These auxiliary processors may be used as a digital signal processor (a special-purpose microprocessor having an architecture suitable for fast execution of signal processing algorithms), as a back-end processor (a slave processor subordinate to the main processing system), as an additional microprocessor or controller for dual or multiple processor systems, or as a coprocessor. They may also be used to manage input/output and/or to perform floating point mathematical operations.

A display system 512 for connecting to a display device 514, wherein the display system 512 may comprise a video display adapter having all of the components for driving the display device, including video memory, buffer, and graphics engine as desired, is included in hardware system 500. Video memory may be, for example, windows random access memory (WRAM), video random access memory (VRAM), synchronous graphics random access memory (SGRAM), and the like. The display device 514 may comprise a cathode ray-tube (CRT) type display such as a monitor or television, or an alternative type of display technology such as a projection-type CRT display, a light-emitting diode (LED) display, a gas or plasma display, an electroluminescent display, a vacuum fluorescent display, a cathodoluminescent (field emission) display, a liquid-crystal display (LCD) overhead projector display, an LCD display, a plasma-addressed liquid crystal (PALC) display, a high gain emissive display (HGED), and so forth.

An input/output (I/O) system 516 for connecting to one or more I/O devices 518, 520, and up to N number of I/O devices 522 is included in hardware system 500. Interface functions between the one or more I/O devices 518-522 may be provided by various controllers or adapters. I/O devices such as a keyboard, mouse, trackball, touchpad, joystick, trackstick, infrared transducers, printer, modem, RF modem, bar code reader, charge-coupled device (CCD) reader, scanner, compact disc read-only memory (CD-ROM), digital versatile disc (DVD), video capture device, touch screen, stylus, electroacoustic transducer, microphone, speaker, and others may be communicatively coupled by various interface mechanisms, such as universal serial bus (USB) port, universal asynchronous receiver-transmitter (UART) port, serial port, IEEE 1394 serial bus port, infrared port, network adapter, parallel port, printer adapter, radio-frequency (RF) communications adapter, and others. Analog or digital communication capabilities between the hardware system 500 and the input/output system 516 and I/O devices 518-522 may be provided for communication with external devices, networks, or information sources. Preferably industry promulgated architecture standards are implemented by system 516 and I/O devices 518-522, including Ethernet IEEE 802 standards (e.g., IEEE 802.3 for broadband and baseband networks, IEEE 802.3z for Gigabit Ethernet, IEEE 802.4 for token passing bus networks, IEEE 802.5 for token ring networks, IEEE 802.6 for metropolitan area networks, and so on), Fibre Channel, digital subscriber line (DSL), asymmetric digital subscriber line (ASDL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on. It is to be understood that modification or reconfiguration of the hardware system 500 of FIG. 3 by one having ordinary skill in the art would not depart from the scope or the spirit of the present invention.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention may be practiced otherwise than as specifically set forth herein.

I claim:

1. A computer implemented method for the automated generation and display of an electronic, graphical representation of the effect of a consumer's credit card usage as a percentage of credit limit on such consumer's credit score, comprising the steps of:
receiving at a credit usage analysis engine data reflecting a consumer's credit limit and current credit card balance for a plurality of credit card accounts of said consumer;
for each said credit card account of said consumer, determining at said credit usage analysis engine a credit card usage categorization selected from a group of categorizations varying from more negative effect on said consumer's credit score to more positive effect on said consumer's credit score; and
transmitting from said credit usage analysis engine an electronic, graphical representation of an effect of credit card usage as a percentage of credit limit on said consumer's credit score for each said credit card account.

2. The method of claim 1, wherein a display showing a more negative effect on said consumer's credit score is indicative of a higher credit card usage as a percentage of credit limit.

3. The method of claim 1, wherein a display showing a more positive effect on said consumer's credit score is indicative of a lower credit card usage as a percentage of credit limit.

4. The method of claim 1, wherein said credit card usage categorization is indicative of an effect of card usage as a percentage of credit limit on consumer credit score.

5. A system for the automated generation and display of an electronic, graphical representation of the effect of a consumer's credit card usage as a percentage of credit limit on such consumer's credit score, comprising:
a credit usage analysis server computer having executable computer code stored thereon executing a credit usage analysis engine adapted to:
receive data reflecting a consumer's credit limit and current credit card balance for a plurality of credit card accounts of said consumer;
for each said credit card account of said consumer, determine a credit card usage categorization selected from a group of categorizations varying from more negative effect on said consumer's credit score to more positive effect on said consumer's credit score; and
transmit an electronic, graphical representation of an effect of credit card usage as a percentage of credit limit on said consumer's credit score for each said credit card account.

6. The system of claim 5, wherein a display showing a more negative effect on said consumer's credit score is indicative of a higher credit card usage as a percentage of credit limit.

7. The system of claim 5, wherein a display showing a more positive effect on said consumer's credit score is indicative of a lower credit card usage as a percentage of credit limit.

8. The system of claim 5, wherein said credit card usage categorization is indicative of an effect of card usage as a percentage of credit limit on consumer credit score.
